(19) United States
(12) Patent Application Publication
(10) Pub. No.: US 2009/0130448 A1
(43) Pub. Date: May 21, 2009

(54) FLEXIBLE MAGNETS HAVING A PRINTABLE SURFACE AND METHODS OF PRODUCTION

(75) Inventors: Tom MORRISSEY, Long Bottom, OH (US); Stephen MCLEVEY, Marietta, OH (US)

Correspondence Address: NIXON PEABODY LLP - PATENT GROUP, 1100 CLINTON SQUARE, ROCHESTER, NY, 14604, US

(73) Assignee: ARNOLD MAGNETIC TECHNOLOGIES, Rochester, NY (US)

(21) Appl. No.: 11/941,112

(22) Filed: Nov. 16, 2007

(51) Int. Cl. B32B 33/00; B05D 5/04; B05D 3/06

(52) U.S. Cl. 428/409; 427/127; 427/514

(57) ABSTRACT

A method of forming a flexible magnetic sheet having a printable surface includes providing a flexible magnetic sheet, applying a coating directly to a surface of the flexible magnetic sheet, and curing the coating to form a printable surface on the flexible magnetic sheet. A flexible magnetic sheet having a printable surface includes a printable coating directly on a surface of the magnetic sheet.

### FIELD OF THE INVENTION

The present invention relates to flexible magnets and, more particularly, to flexible magnets having a printable surface and methods of their production.

### BACKGROUND

Flexible permanent magnetic sheeting is well-known and commonly used in conjunction with a printable substrate to display decoration or information, such as promotional and/or advertising information. Its magnetic attraction to metal surfaces, such as automobiles, metal building materials, refrigerators, metal doors, and other highly visible surfaces, provides an ideal property for attaching the magnetic sheeting to these and other surfaces to display information. Since the materials used in construction of flexible permanent magnetic sheeting are typically inherently dark, it is often desirable to attach a printable substrate material to a surface of the magnetic sheeting. The printable substrate can then be printed with the desired decoration and/or information.

Flexible permanent magnetic sheeting is typically supplied commercially in large sheets or rolls and can be readily cut or stamped into desired shapes and sizes. Often, a printable substrate is attached to the flexible permanent magnetic sheeting, and then the sheeting is stamped or cut into sizes suitable for distribution in mass-mailings, newspaper inserts, box toppers, coupons, business cards, calendars, greeting cards, postcards, handouts, signage, and so forth.

A printable substrate can typically be adhered to the flexible permanent magnet using lamination methods. Lamination methods involve an adhesive material between the magnetic sheeting and the printable substrate. Attaching printable substrates to magnetic sheeting by lamination methods can be time-consuming and expensive. Lamination methods are particularly problematic in that they cause tension between the magnetic sheeting and the printable substrate, resulting in printing problems. Lamination methods also often require trimming of the edges of the magnetic sheeting after the substrate is laminated to it.

Other methods of providing flexible permanent magnetic sheeting with a printable substrate are described in U.S. Pat. No. 7,128,798 to Boudouris et al., which involve application of a magnetic layer directly to a printable substrate at elevated temperatures where the magnetic layer is pliable and/or in a plastic form. According to this method, a so-called magnetic hot-melt is applied to a printable substrate using a slot-die apparatus.

However, cost-effective methods are needed that involve application of a printable substrate to flexible permanent magnetic sheeting as it is typically commercially supplied (e.g., in large sheet or roll form), without having to alter the physical properties of the flexible permanent magnetic sheeting and without having to use an adhesive. In addition, there is a need for improvement in coating and ink systems that may be used as printable substrates on flexible permanent magnetic sheeting.

The present invention is directed to these and other improvements to the current state of the art.

### SUMMARY

A method of forming a flexible magnetic sheet having a printable surface in accordance with embodiments of the present invention includes providing a flexible magnetic sheet, applying a coating directly to a surface of the flexible magnetic sheet, and curing the coating to form a printable surface on the flexible magnetic sheet.

A flexible magnetic sheet having a printable surface in accordance with other embodiments of the present invention includes a printable coating directly on a surface of the magnetic sheet.

The present invention provides a number of advantages, including providing alternative, cost-effective methods of forming a flexible magnetic sheet having a printable surface. This method eliminates the need to laminate the printable substrate to the top surface of the magnet. Accordingly, the method of the present invention is advantageous not only for cost saving purposes but it also eliminates the issues with tension between the magnet and the printable substrate, which can cause printing problems. The coating used in accordance with the method of the present invention also eliminates the need to trim the edges of the magnet after the substrate is laminated to it.

The method also provides the advantage of readily applying a printable substrate to a commercially supplied flexible permanent magnetic sheet product, without having to alter the physical properties of the flexible permanent magnetic sheeting. Accordingly, large rolls or sheets of flexible permanent magnetic materials can be readily coated with a printable substrate. In addition, new technologies in coating and ink systems may be adapted for use as printable substrates to provide an advantage in adherence to the magnetic sheet and improvements in curing processing.

These and other advantages, which will be apparent to those of ordinary skill in the art, are provided by the present invention.

### BRIEF DESCRIPTION OF THE DRAWINGS

FIG. 1 is a cross-sectional view of a flexible magnetic sheet having a printable surface in accordance with embodiments of the present invention;

FIG. 2 is a flowchart of a method for forming a flexible magnetic sheet having a printable surface in accordance with embodiments of the present invention.

### DETAILED DESCRIPTION OF THE INVENTION

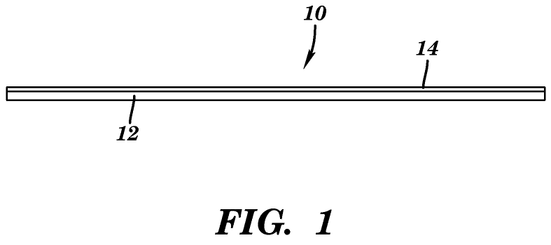

A flexible magnetic sheet having a printable surface in accordance with embodiments of the present invention is illustrated in FIG. 1. The flexible magnetic product 10 has a flexible magnetic sheet 12 and a printable substrate 14. As illustrated, the printable substrate 14 is in direct contact with the flexible magnetic sheet 12 (i.e., there is no adhesive layer between the flexible magnetic sheet 12 and the printable substrate 14). As described in greater detail below, the printable substrate 14 is a printable coating.

Flexible magnetic sheet 12 is typically constructed of ferrite materials or rare earth flexible bonded material. However, the present invention is not limited to any particular magnetic material. Flexible permanent magnetic sheeting is commonly produced by extrusion processes, calendaring, or rolling of pelletized compound(s) between two rollers to form a continuous sheet. Alternatively, a combination of extruder/calendaring processes can be used in forming flexible permanent magnetic sheeting. Flexible magnetic sheet 12 may range in thickness from about 0.005 inches to about 0.375 inches, although magnetic sheets with other thicknesses may also be used. Printable substrate 14, which is a printable coating that has been dried or cured, is typically less than about 0.001 inches in thickness.

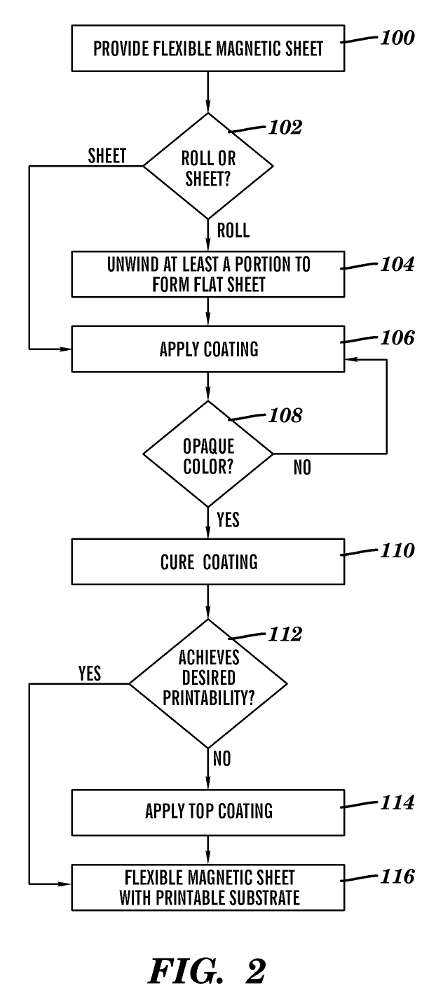

A method of forming a flexible magnetic sheet having a printable surface in accordance with embodiments of the present invention is illustrated in FIG. 2. In step 100, a flexible magnetic material is provided. Flexible magnetic sheeting is readily available and is supplied in large sheets or rolls. Often, flexible magnetic materials in roll form provide a convenient way to ship flexible magnetic materials. Roll form may also provide certain advantages for processing, including convenience in applying a printable substrate to a surface of the flexible magnetic material in accordance with embodiments of the present invention.

In Step 102, it is determined whether the flexible magnetic sheet material is supplied in roll form or in sheet form (e.g., flat layers). If the magnetic sheet material is in roll form, at least a portion of the roll is unwound to form a flat sheet. How the rolled material is unwound and the necessary length of unwound material needed will depend on the particular processing methods used in the steps further outlined in FIG. 2. Depending on how the flexible magnetic material is provided, either the “Sheet” branch or “Roll” branch of Step 102 is taken. If the “Roll” branch is taken, the method may require Step 104, which involves unwinding the roll to a length suitable for further processing the flexible magnetic sheet material, as set forth in FIG. 2. If the “Sheet” branch is taken, the method proceeds to Step 106.

Step 106 involves applying coating to a surface of the flexible magnetic sheet material. In carrying out this step of the method of the present invention, application of a coating directly to a surface of a flexible magnetic sheet may involve a variety of application methods and techniques including, but not limited to, roll applicator methods and screen applicator methods. Whatever particular method is employed, Step 106 involves application of a coating directly to a surface of the magnetic sheet. Thus, the method of the present invention is distinguishable from lamination methods, which involve the use of an adhesive layer between the magnetic sheeting and the printable substrate. An advantage of the method of the present invention is that it does not require the application of an adhesive layer. Accordingly, a coating is applied directly to a surface of the magnetic sheet material to form a flexible magnetic sheet product having a printable surface directly on a surface of the magnetic sheet with no adhesive layer between the magnetic sheet and the printable surface.

Roll applicator systems for applying coatings to relatively thin substrates are well-known. Examples of suitable roll applicator coating systems that may be used in accordance with Step 106 include, without limitation, gravure, anilox, flexo, and offset applicator systems. All of these systems use a roll that has a pattern engraved in it that picks up a specific amount of coating and either applies it directly to the magnetic material or to a transfer roll that then applies the coating to the magnet. In addition, other coating techniques, such as slot die coating, meyer rod coating, knife coating, reverse roll coating, immersion dip coating, curtain coating methods, and others can be used to apply the coating.

Application of a coating using a roll applicator system or technique provides a particularly convenient and efficient way of coating a surface of a flexible magnetic sheet which is supplied in roll form. According to this particular embodiment, a roll of flexible magnetic sheet material is supplied on a spool or core and permitted to “unwind” as it is fed as a single layer into a roll applicator system. The coating is then applied to a surface of the magnetic sheet material and, following subsequent curing (described below), the flexible magnetic sheet can be wound on a new spool or core to provide a flexible magnetic sheet having a printable surface in roll form.

Alternatively, the flexible magnetic sheet material may be supplied as a single flat sheet that is not in roll form. According to this embodiment, it may be preferable to apply the coating with a screen applicator system. Screen application can be done in a cut sheet form. The material is cut into sheets and then the coating is applied for the printable surface.

Suitable coatings of the present invention include liquid coatings and solid coatings (e.g., powders and dry suspensions). Preferably, but not necessarily, the coating is a color coating (e.g., a coating containing a dye or pigment). While the particular coating composition may vary, preferable coatings include UV-based, water-based, solvent-based, and/or toner-based coatings. These and other types of coatings are commercially available.

Toner-based coatings that may be used in accordance with the method of the present invention may include, without limitation, dry-suspensions and liquid-suspensions. Toner based coatings are electrically charged so that they adhere to a drum, plate, or piece of paper charged with the opposite polarity. The coating is then fused to the material by the use of heat. Dry toner is a dry powder-like material that is laid on the material and then fused to the material. Liquid suspended toner is a toner that is transported in liquid format to be applied to the material in a liquid state and then fused to the material.

Step 106 of FIG. 2 may further involve application of a primer to the flexible permanent magnetic sheeting. Application of a primer may be desirable to provide increased adhesion of the coating to the flexible permanent magnetic sheeting. The primer may be applied prior to application of the coating or in conjunction with the coating, using any of the application methods described supra. When employed, a primer typically has a thickness of less than about 0.001 inches. A particularly suitable primer is a UV-based primer, which is immediately curable by application of UV light. When employed, a UV-based primer may be used in conjunction with any of the above-described coatings. In one embodiment, the primer may be a clear primer. Alternatively, primers containing inks or pigments may also be used.

In Step 108 of FIG. 2, it is determined whether the coating is sufficiently opaque for the desired end product. If the coating is sufficiently opaque, the “Yes” branch is taken and the method proceeds to Step 110. However, if the coating is not sufficiently opaque, the “No” branch is taken and the flexible magnetic sheet material is further processed through Step 106. Subsequent application(s) of color coating can produce a printable surface having a more opaque appearance.

Step 110 of FIG. 2 involves curing the coating. When a liquid coating is applied, curing may be carried out by drying the coating. Suitable methods for drying the coating include, without limitation, UV curing, air drying, and heated oven drying. Drying times and conditions (e.g., temperature, humidity, etc.) may vary, depending on the particular coating used. When UV-based primers and/or coatings are applied directly to a surface of a flexible magnetic sheet, the primers and/or coatings are preferably UV-cured. UV-curing is a photochemical process in which intense ultraviolet light is used to instantly cure or “dry” UV-based coatings. One of the benefits of UV-curing technology is that a coating can be fully cured instantly, which enables the magnetic sheet material to be stacked or wound into roll form almost immediately following application and subsequent curing of the coating.

In Step 112, it is determined whether the printable surface (i.e., the cured coating) has achieved the desired printability. If the printable surface achieves the desired printability, the “Yes” branch is taken and a flexible magnetic sheet product having a printable surface is achieved. If the printable surface does not achieve the desired printability, the “No” branch is taken and a top coating can be applied, as set forth in Step 114. Thus, in addition to the above-described coatings and/or primers, it may be desirable to apply, via any of the above-described methods, a top coating to the coating to enhance printability of the surface. Alternatively, top-coatings may be applied via analox, gravure, screen, or any other method used to apply a tope coating to the magnetic sheet. Suitable top-coatings may include, without limitation, UV top coating, water-based top coating, and solvent-based top coating. When employed, the top coating is typically applied as a thin layer less than about 0.001 inches thick.

Following application of the top coating as set forth in Step 114, a flexible magnetic sheet having a printable substrate is achieved, as set forth in Step 116.

The method of the present invention may also involve applying a coating to both surfaces of the flexible permanent magnetic sheeting. Accordingly, a coating may be applied to a first surface of a flexible magnetic sheet as described herein and then re-processed so that a coating is applied on a surface opposite the surface previously coated. Alternatively, a roll applicator or screen applicator may be employed which is capable of coating both surfaces of a flexible magnetic sheet either simultaneously or with very little time between applications. Both surfaces may also be simultaneously cured. Having both surfaces of a flexible magnetic sheet coated may be advantageous in certain applications. For example, in digital printing presses a flexible magnetic sheet having a color coating on both surfaces can help permit detection of the printable surface by an infra-red light.

In one embodiment, UV and water-based coatings are used. Some of the UV coatings require the use of a primer on the magnet. The UV primer is applied using an analox roll and then UV cured. The UV coating is then applied using the same style of analox roll with a UV coater. The material is rewound for further processing or applying the print top coating that may be needed.

In an alternative embodiment, a water-based coating is applied to a magnetic sheet material using a gravure roll with a doctor blade wipe (or on a flexo style press). After the coating is applied, the material is run through an oven for quick drying. The material is then rewound for further processing or applying the current print top coating that is used. The print top coating is applied in the same manner as color coating. The products that are produced from the coated material can be in either sheet or roll form. Sheet product is used in printing applications such as digital presses that use sheets, screen printing, offset printing, or any other printing method that uses a sheet product. The roll product is used in print applications that are web fed and need printable product in a roll form such as digital, flexo, or any other printing method that uses a roll product.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed:

1. A method of forming a flexible magnetic sheet having a printable surface, the method comprising:
providing a flexible magnetic sheet;
applying a coating directly to a surface of the flexible magnetic sheet; and
curing the coating to form a printable surface on the flexible magnetic sheet.

2. The method according to claim 1, wherein the applying is carried out with a roll applicator.

3. The method according to claim 2, wherein the roll applicator is selected from one of a gravure, anilox, flexo, and offset applicator.

4. The method according to claim 1, wherein the applying is carried out with a screen applicator.

5. The method according to claim 1, wherein the coating comprises a color coating.

6. The method according to claim 5, wherein the color coating is selected from one or more of a UV-based, water-based, solvent-based, or toner-based color coating.

7. The method according to claim 5, wherein the coating further comprises a primer.

8. The method according to claim 7, wherein the primer is a UV-based primer.

9. The method according to claim 7, wherein the applying further comprises applying the primer and the color coating sequentially.

10. The method according to claim 7, wherein the applying further comprises applying the primer and the color coating simultaneously.

11. The method according to claim 8, wherein the coating comprises a UV-based primer and a UV-based color coating.

12. The method according to claim 11, wherein the curing further comprises subjecting the coating to an ultra violet curing system.

13. The method according to claim 1, wherein the curing further comprises drying the coating.

14. The method according to claim 6, wherein the coating is a toner-based coating selected from one of a dry suspension and a liquid suspension.

15. The method according to claim 1 further comprising contacting the coating with a top-coating to enhance printability of the surface.

16. A flexible magnetic sheet having a printable surface, wherein the printable surface comprises a printable coating directly on a surface of the magnetic sheet.

17. The magnetic sheet according to claim 16, wherein the coating comprises a color coating.

18. The magnetic sheet according to claim 17, wherein the coating further comprises a primer.

19. The magnetic sheet according to claim 18, wherein the primer is a UV-based primer.

20. The magnetic sheet according to claim 19, wherein the coating comprises a UV-based primer and a UV-based color coating.

21. The magnetic sheet according to claim 20, wherein the primer and the color coating are UV cured.

22. The magnetic sheet according to claim 16 further comprising a top-coating which enhances printability of the surface.
